(19) United States
(12) Patent Application Publication
(10) Pub. No.: US 2026/0270555 A1
(43) Pub. Date: Sep. 10, 2026

(54) IMAGING DEVICE, IMAGING SIGNAL PROCESSING DEVICE, AND IMAGING SYSTEM

(71) Applicant: Sony Group Corporation, Tokyo (JP)

(72) Inventors: Koji Kamiya, Kanagawa (JP); Keiichi Kimura, Kanagawa (JP); Yasutaka Nakashima, Kanagawa (JP); Kenichi Sakurai, Kanagawa (JP)

(21) Appl. No.: 19/164,378

(22) PCT Filed: Mar. 22, 2024
(86) PCT No.: PCT/JP24/11284

§ 371 Date: Sep. 11, 2025

(30) Foreign Application Priority Data
Apr. 4, 2023 (JP) 2023-060889

(51) Int. Cl. H04N 23/66; H04N 23/60

(52) U.S. Cl. CPC H04N 23/66; H04N 23/64

(57) ABSTRACT

An imaging device includes: an imaging element unit capable of outputting a video signal at m-fold speed with a specific resolution; a signal processing unit in which part of processing is compatible with a video signal at up to n-fold speed, which is lower than the m-fold speed, with the specific resolution; a transmission unit that transmits a video signal output from the signal processing unit to an imaging signal processing device; and a control unit that changes a processing process of the signal processing unit in a case of performing imaging at the m-fold speed with the specific resolution. The imaging signal processing device includes a signal processing unit capable of executing the part of processing in the imaging device corresponding to a video signal of m-fold speed with the specific resolution.

### TECHNICAL FIELD

The present technology relates to a technical field of an imaging device, an imaging signal processing device, and an imaging system.

### BACKGROUND ART

There is known an imaging system that performs high speed imaging with high resolution in an imaging device and transmits a video signal from the imaging device to a camera control unit.

Patent Document 1 below discloses a technique related to such an imaging system.

### CITATION LIST

### Patent Document

Patent Document 1: Japanese Patent No. 4475225

### SUMMARY OF THE INVENTION

### Problems to be Solved by the Invention

Meanwhile, in a 4K-RGB camera of a standard three-plate image sensor, a processing capability of a (16 bits)×(148M)×4×(3 channels (RGB))≈28 Gbps class is required for signal processing of a frame frequency of a standard speed (59.94P, 50P (P is progressive scan)). As a matter of course, when the imaging frame frequency increases, a signal processing capability proportional to the imaging frame frequency is required.

Then, for example, even if imaging can be performed at 4-fold speed as the imaging capability of the image sensor, if the signal processing capability is not quadruple, 4-fold speed imaging cannot be performed.

Therefore, the present disclosure proposes a technology that enables an imaging system using an imaging device having a standard signal processing capability to be compatible with imaging at a high double speed exceeding the signal processing capability.

### Solutions to Problems

An imaging device according to the present technology includes: an imaging element unit capable of outputting a video signal at m-fold speed with a specific resolution; a signal processing unit in which part of processing is compatible with a video signal at up to n-fold speed, which is lower than the m-fold speed, with the specific resolution; a transmission unit that transmits a video signal output from the signal processing unit to an imaging signal processing device; and a control unit that changes a processing process of the signal processing unit in a case of performing imaging at the m-fold speed with the specific resolution.

An imaging signal processing device according to the present technology includes: a transmission unit that receives a video signal output from an imaging device including an imaging element unit capable of outputting a video signal of m-fold speed with a specific resolution, a part of processing being compatible with a video signal of up to n-fold speed lower than the m-fold speed with the specific resolution; a signal processing unit capable of executing the part of processing in the imaging device corresponding to the video signal at the m-fold speed with the specific resolution; and a control unit that performs control for causing the signal processing unit to execute the part of processing on the video signal at the m-fold speed with the specific resolution in a case where the imaging device outputs the video signal at the m-fold speed with the specific resolution.

In a case where the imaging device is not compatible with processing of the video signal at m-fold speed with the specific resolution, processing of the video signal at m-fold speed is performed on the imaging signal processing device side. The imaging device side deals it by changing the processing process.

Note that m and n are assumed to be natural numbers. However, m and n are not necessarily limited to natural numbers. At least m>n.

### BRIEF DESCRIPTION OF DRAWINGS

FIG. 1 is a block diagram of a system camera according to an embodiment of the present technology.

FIG. 2 is a block diagram of a 4K video processing unit of a camera control unit according to the embodiment.

FIG. 3 is an explanatory diagram of processing in a case of 4K standard speed imaging according to the embodiment.

FIG. 4 is an explanatory diagram of processing in a case of 4K2-fold speed imaging of the embodiment.

FIG. 5 is an explanatory diagram of processing in a case of 4K 4-fold speed imaging of the embodiment.

FIG. 6 is a flowchart of a processing example at power-on according to the embodiment.

FIG. 7 is a flowchart of a processing example in a case of 4K 4-fold speed imaging of the embodiment.

### MODE FOR CARRYING OUT THE INVENTION

Hereinafter, an embodiment will be described in the following order.
<1. System camera configuration>
<2. Processing of standard speed, 2-fold speed, and 4-fold speed imaging>
<3. Processing example>
<4. Summary and modification>

Note that, in the present disclosure, “4K” refers to a video having a resolution of 3840×2160 pixels, and this resolution is referred to as “4K resolution”. In the present disclosure, the double speed is represented by “x”. For example, “4K4x” indicates 4-fold speed imaging with 4K resolution, “4K2x” indicates 2-fold speed imaging with 4K resolution, and “4K1x” indicates 1-fold speed (standard speed) imaging with 4K resolution.

### 1. System Camera Configuration

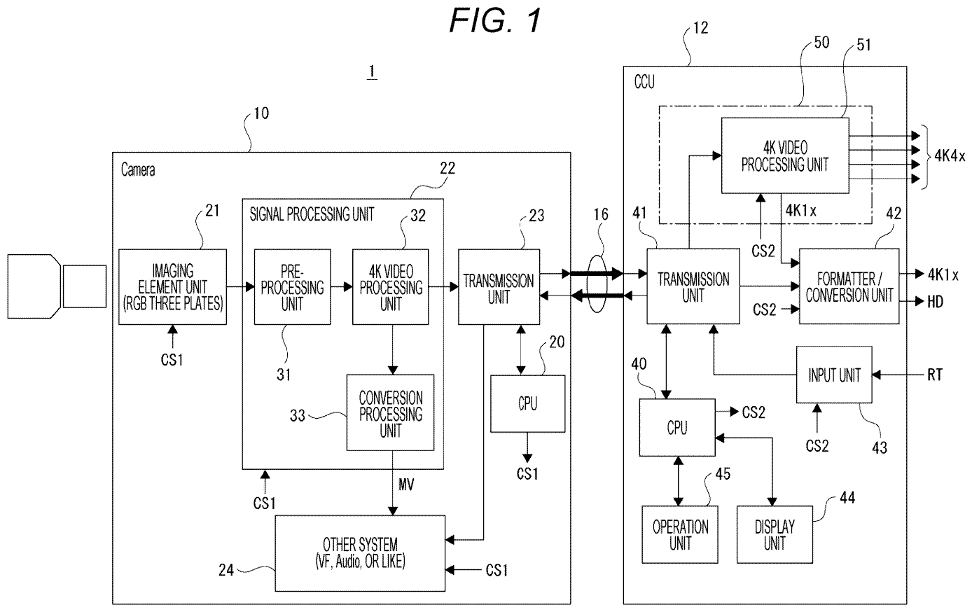

FIG. 1 illustrates a configuration example of a system camera 1 according to an embodiment. The system camera 1 includes a camera 10 and a camera control unit (hereinafter, CCU) 12.

The system camera 1 is an example of an imaging system of the present disclosure, the camera 10 is an example of an imaging device, and the CCU 12 is an example of an imaging signal processing device.

The camera 10 performs imaging to generate a video signal, and outputs the video signal to the CCU 12 via a composite optical fiber cable 16.

The CCU 12 processes the video signal input from the camera 10 and transmits the processed video signal to a recording device, a switcher, or the like (not illustrated) in a predetermined transmission format.

The composite optical fiber cable 16 is formed by combining, for example, optical fibers for transmission and reception and meta cables for power supply lines and control. As a result, the camera 10 and the CCU 12 can mutually transmit a video signal and a control signal.

In the system camera 1, for example, the camera 10 is arranged in a studio, and the CCU 12, the recording device, the switcher, and the like are arranged in a sub-adjustment room.

For example, when a program is recorded by the camera 10 of the studio, the video signal and the audio signal are transmitted to the CCU 12 of the sub-adjustment room via the composite optical fiber cable 16.

Then, the video signal and the audio signal processed by the CCU 12 are output to the recording device or the switcher via a cable (not illustrated). The recording device and the switcher perform signal processing such as recording, editing, and sending of video signals and audio signals.

A configuration of the camera 10 will be described.

The camera 10 includes a central processing unit (CPU) 20, an imaging element unit 21, a signal processing unit 22, a transmission unit 23, and another system 24.

The imaging element unit 21 is configured as a three-plate type including an image sensor by, for example, a complementary metal oxide semiconductor (CMOS), a charge-coupled device (CCD), or the like for each of R, G, and B. Then, an R video signal, a G video signal, and a B video signal are output by progressive scanning. In the present embodiment, it is assumed that the imaging element unit 21 can perform not only imaging at a standard speed of 4K1x but also high-frame-rate imaging of 4K2x or 4K4x.

The signal processing unit 22 includes one or a plurality of video processor chips or the like. The signal processing unit 22 includes a pre-processing unit 31, a 4K video processing unit 32, and a conversion processing unit 33 as processing functions. Note that, although not illustrated, a buffer memory for temporarily storing a video signal in the process of processing the video signal by the signal processing unit 22 is provided in the signal processing unit 22 or the camera 10.

The pre-processing unit 31 performs A/D conversion processing, gain adjustment processing, defect correction processing, and the like of the video signal. The pre-processing unit 31 can perform processing corresponding to 4K4x imaging by the imaging element unit 21. For example, the pre-processing unit 31 can perform pre-processing as 4-fold speed processing or 1-fold speed processing of four systems in parallel.

The 4K video processing unit 32 performs necessary luminance and color processing including knee processing, gamma processing, color matrix processing, and the like on the preprocessed video signal. These pieces of processing are collectively referred to as video signal processing.

The 4K video processing unit 32 has a processing capability of executing video signal processing corresponding to 4K2x imaging. On the other hand, it is assumed that the processing capability for 4K4x imaging is not sufficient.

The conversion processing unit 33 performs conversion processing for generating a monitor video signal MV to be displayed on a viewfinder (not illustrated) of the camera 10. That is, the conversion processing unit 33 performs processing of converting, for example, the 4K video signal at 1-fold speed processed by the 4K video processing unit 32 into a high definition (HD) video signal, and uses this as the monitor video signal MV.

Note that the other system 24 indicates another functional unit not illustrated in the camera 10. A view finder, an audio circuit, and the like are included. The monitor video signal MV is supplied to the viewfinder and displayed, so that a camera operator operating the camera 10 can confirm the captured video.

The video signal that has passed through the 4K video processing unit 32 of the signal processing unit 22 is transmitted to the CCU 12 by the transmission unit 23. The transmission unit 23 transmits the video signal to the CCU 12 in an uncompressed manner. Furthermore, the transmission unit 23 can also transmit the video signal to the CCU 12 after compressing the video signal.

The CPU 20 functions as a control unit of the camera 10. The CPU 20 transmits a control signal CS1 to each unit to control the operation of each unit. For example, the CPU 20 instructs the imaging element unit 21 on the reading speed. In addition, the CPU 20 controls a processing process in the signal processing unit 22. In addition, the CPU 20 controls the transmission processing with respect to the transmission unit 23. In addition, the CPU 20 can perform information communication with a CPU 40 of the CCU 12 by communication via the transmission unit 23.

Next, a configuration of the CCU 12 will be described.

The CCU 12 includes the CPU 40, a transmission unit 41, a formatter/conversion unit 42, an input unit 43, a display unit 44, and an operation unit 45.

The transmission unit 41 transmits and receives signals to and from the transmission unit 23 of the camera 10. The transmission unit 41 receives the video signal transmitted from the camera 10 and outputs the video signal to the formatter/conversion unit 42. In a case where the video signal is subjected to compression processing, the transmission unit 41 can also perform decompression (extension) processing on the compression.

The formatter/conversion unit 42 performs format processing for performing serial digital interface (SDI) transmission or Internet protocol (IP) transmission of the 4K video signal to, for example, the recording device, the switcher, or the like, and processing for converting the 4K video signal into an HD video signal. Then, the formatter/conversion unit 42 outputs a 4K video signal or an HD video signal.

The input unit 43 inputs various signals and delivers the signals to the transmission unit 41. For example, a return signal RT is input. The return signal RT is, for example, a video captured by another camera, is transmitted from the transmission unit 41 to the camera 10, and is used for display on a viewfinder, another display device, or the like.

The display unit 44 displays an operation status and the like in the CCU 12.

The operation unit 45 includes an operator with which an operator of the CCU 12 can perform various operations. The display unit 44 and the operation unit 45 may be integrated as a graphical user interface (GUI) device using a touch panel.

The CPU 40 functions as a control unit that controls each unit in the CCU 12. The CPU 40 transmits a control signal CS2 to each unit to control the operation of each unit.

For example, the CPU 40 controls a transmission operation of the transmission unit 41, decompression processing, and the like, and processing of the formatter/conversion unit 42. In addition, the CPU 40 controls a display operation of the display unit 44. In addition, the CPU 40 can perform information communication with the CPU 20 of the camera 10 by communication via the transmission unit 41.

In the CCU 12, an option board 50 can be mounted in a device housing, and the option board 50 is mounted with a 4K video processing unit 51. The 4K video processing unit 51 has a processing capability capable of executing video signal processing similar to that of the 4K video processing unit 32 of the camera 10 corresponding to 4K4x imaging.

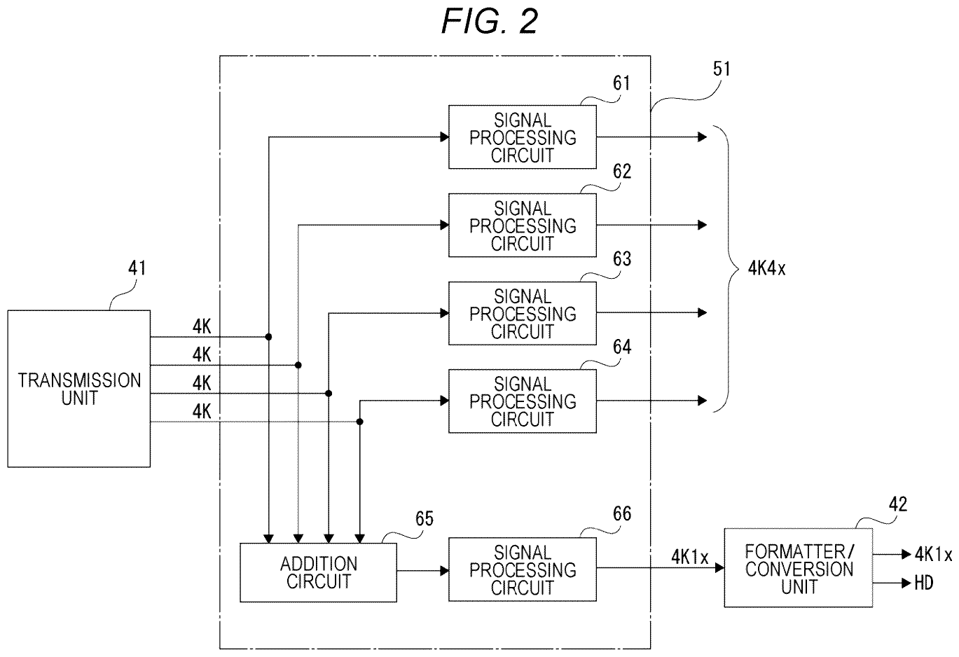

FIG. 2 illustrates a configuration example of the 4K video processing unit 51. The 4K video processing unit 51 includes, for example, signal processing circuits 61, 62, 63, and 64 each having a processing capability of video signal processing equivalent to 4K1x. In a case where a 4K4x video signal is transmitted from the camera 10 to the transmission unit 41, the transmission unit 41 sequentially transmits the 4K4x video signal to the signal processing circuits 61, 62, 63, and 64, for example, for each frame, thereby implementing video signal processing equivalent to 4K4x in the entire signal processing circuits 61, 62, 63, and 64.

Then, the 4K video processing unit 51 outputs a 4K4x video signal to a switcher or the like at a subsequent stage as a 4-system parallel output.

Furthermore, the 4K video processing unit 51 includes an addition circuit 65 and a signal processing circuit 66. The addition circuit 65 adds inputs to the signal processing circuits 61, 62, 63, and 64 to generate a 4K1x video signal. Similarly to the signal processing circuit 61, the signal processing circuit 66 has a processing capability of video signal processing equivalent to 4K1x. The 4K1x video signal output from the addition circuit 65 is subjected to video signal processing by the signal processing circuit 66 and supplied to the formatter/conversion unit 42.

As will be described later, in a case where 4K4x video signal processing is performed, the processing process is changed such that the transmission unit 41 does not output a video signal to the formatter/conversion unit 42 but outputs a video signal to the 4K video processing unit 51. Even in this case, the formatter/conversion unit 42 can output the 4K1x video signal and the HD video signal converted from the 4K1x video signal by receiving the 4K1x video signal from the 4K video processing unit 51.

With the above configuration, the system camera 1 can be switched and operated to a system camera capable of high-frame-rate imaging at 4-fold speed by adding the option board 50 on the CCU 12 side to the standard camera 10 and the CCU 12.

### 2. Processing of Standard Speed, 2-Fold Speed, and 4-Fold Speed Imaging

Hereinafter, an example will be described in which, in the system camera 1 capable of imaging up to 4K2x, the option board 50 is added to the CCU 12 side, and the CPUs 20 and 40 have necessary software options, so that the system camera 1 can be operated as a supermotion camera at 4-fold speed.

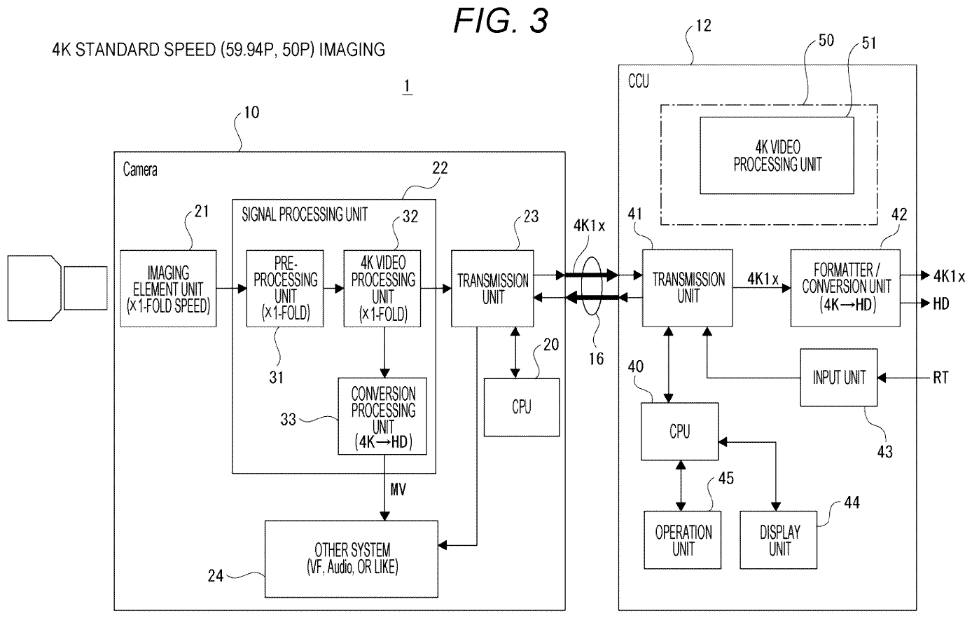

FIGS. 3, 4, and 5 illustrate processing and a signal path of each unit in the configuration of FIG. 1 in each case of 4K1x imaging, 4K2x imaging, and 4K4x imaging, and it is assumed that a change in processing and a change in a signal path of each unit can be seen by comparing the respective drawings.

First, FIG. 3 illustrates processing executed by each unit under the control of the CPUs 20 and 40 in a case where 4K1x imaging, that is, imaging in a general 4K video format (59.94P, 50P) is performed.

In the imaging element unit 21, imaging is performed at 1-fold speed. In the signal processing unit 22, the pieces of processing of the pre-processing unit 31 and the 4K video processing unit 32 are executed at 1-fold speed, and an uncompressed 4K1x video signal is transmitted from the transmission unit 23 to the CCU 12.

Furthermore, in the conversion processing unit 33 of the signal processing unit 22, the 4K1x video signal subjected to the video signal processing in the 4K video processing unit 32 is converted into an HD video signal. The HD video signal is a monitor video signal MV supplied to the viewfinder.

The 4K1x video signal output from the camera 10 is input to the transmission unit 41 of the CCU 12. The transmission unit 41 transmits the 4K1x video signal to the formatter/conversion unit 42. The formatter/conversion unit 42 performs necessary format processing for SDI transmission and the like on the 4K1x video signal and outputs the 4K1x video signal. Furthermore, the formatter/conversion unit 42 converts the 4K1x video signal into an HD video signal and outputs the HD video signal.

In a case where 4K1x imaging is performed, the processing flow as illustrated in FIG. 3 is performed. In this case, the 4K video processing unit 51 is not used on the CCU 12 side. In other words, 4K1x imaging can be executed even when the option board 50 is not mounted.

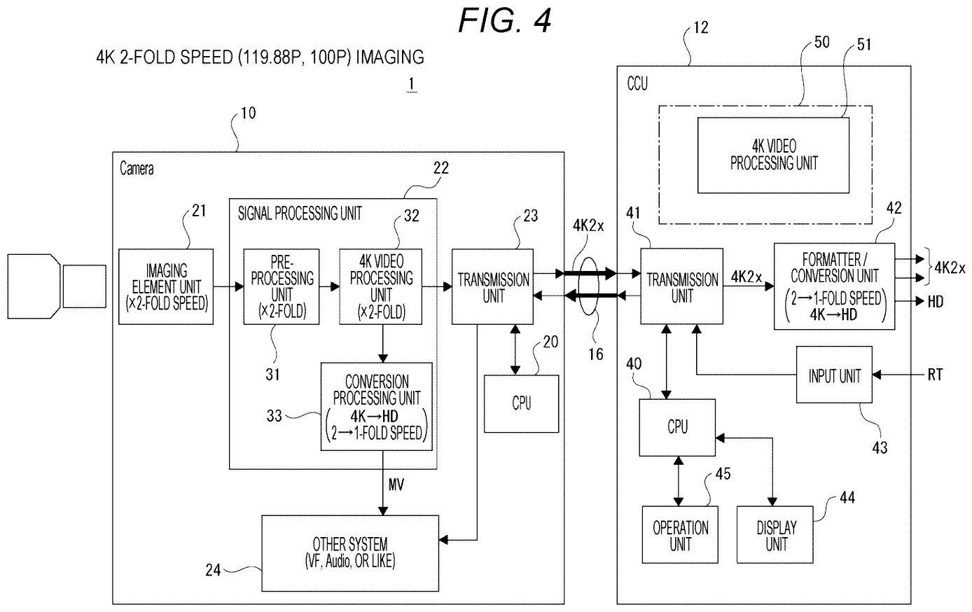

Next, FIG. 4 illustrates processing executed by each unit under the control of the CPUs 20 and 40 in a case where 4K2x imaging, that is, imaging in a 4K video format (119.88P, 100P) at 2-fold speed is performed.

In the imaging element unit 21, imaging is performed at 2-fold speed. In the signal processing unit 22, the pieces of processing the pre-processing unit 31 and the 4K video processing unit 32 are executed at 2-fold speed, and the 4K2x video signal is sent from the transmission unit 23 to the CCU 12 in an uncompressed manner.

Furthermore, in the conversion processing unit 33 of the signal processing unit 22, the 4K2x video signal subjected to the video signal processing in the 4K video processing unit 32 is converted into an HD video signal and also converted from a 2-fold speed to a 1-fold speed. This HD video signal becomes the monitor video signal MV supplied to the viewfinder.

The 4K2x video signal output from the camera 10 is input to the transmission unit 41 of the CCU 12. The transmission unit 41 transmits the 4K2x video signal to the formatter/conversion unit 42. The formatter/conversion unit 42 performs necessary format processing on the 4K2x video signal and outputs the 4K2x video signal. Furthermore, the formatter/conversion unit 42 converts the 4K2x video signal into a 1-fold speed (4K1x), further converts the video signal into an HD video signal, and outputs the HD video signal.

In a case where 4K2x imaging is performed, the processing flow as illustrated in FIG. 4 is performed. Also in this case, the 4K video processing unit 51 is not used on the CCU 12 side. Therefore, 4K2x imaging can be executed even if the option board 50 is not attached.

However, for this 4K2x imaging, twice the processing capability (processing speed or parallel processing capability) is required for imaging, pre-processing, and video signal processing in the camera 10, and broadband digital optical transmission of about 24 Gbps is also required for transmission through the composite optical fiber cable 16.

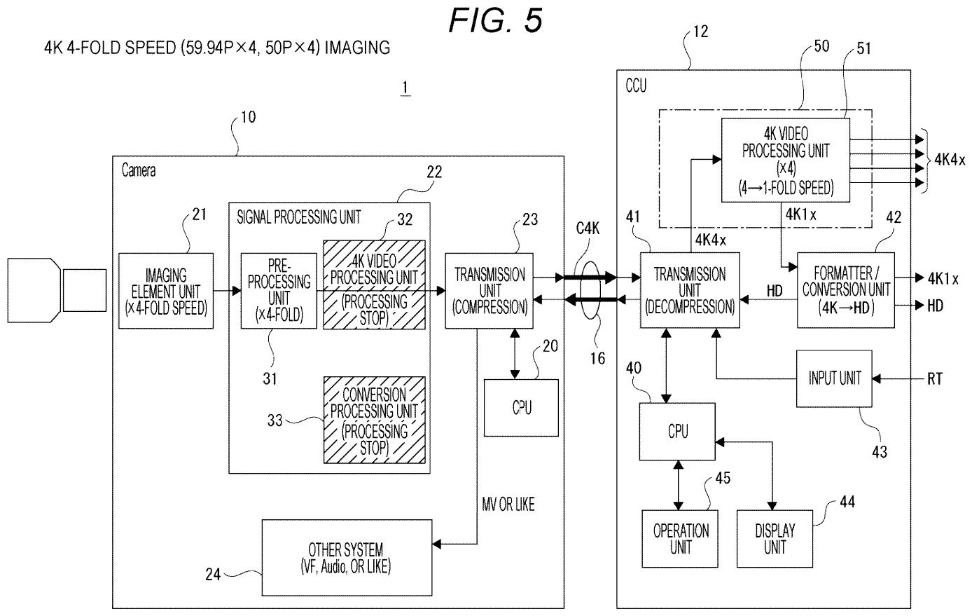

Next, FIG. 5 illustrates processing executed by each unit under the control of the CPUs 20 and 40 in a case where 4K4x imaging, that is, imaging in a 4K video format (59.94P×4, 50P×4) at 4-fold speed is performed.

In the imaging element unit 21, imaging is performed at 4-fold speed. In the signal processing unit 22, the processing of the pre-processing unit 31 is executed at 4-fold speed. However, the processing of the 4K video processing unit 32 is skipped. That is, video signal processing by the 4K video processing unit 32 is not performed on the camera 10 side.

The transmission unit 23 performs compression processing on the 4K4x video signal in a state where the video signal processing is not performed. Then, the compressed video signal C4K is transmitted to the CCU 12.

Furthermore, the conversion processing unit 33 of the signal processing unit 22 does not perform the conversion processing in response to the fact that the processing of the 4K video processing unit 32 is not performed.

The compressed video signal C4K output from the camera 10 is input to the transmission unit 41 of the CCU 12. The transmission unit 41 performs decompression processing on the compression to obtain a 4K4x video signal before the compression, and supplies the 4K4x video signal to the 4K video processing unit 51.

With the configuration illustrated in FIG. 2, the 4K video processing unit 51 performs video signal processing on the 4K4x video signal by parallel processing, and outputs the 4K4x video signal as, for example, signals of four systems.

Furthermore, the 4K video processing unit 51 generates a 4K1x video signal with the configuration illustrated in FIG. 2 and supplies the 4K1x video signal to the formatter/conversion unit 42. The formatter/conversion unit 42 performs necessary format processing on the 4K1x video signal and outputs the 4K1x video signal. Furthermore, the formatter/conversion unit 42 converts the 4K1x video signal into an HD video signal and outputs the HD video signal.

Furthermore, the HD video signal obtained by the formatter/conversion unit 42 is transmitted from the transmission unit 41 to the camera 10, and is supplied from the transmission unit 23 to the viewfinder as the monitor video signal MV. That is, in this case, since the processing of the conversion processing unit 33 is not performed, the camera 10 receives the monitor video signal MV from the CCU 12 and performs the viewfinder display.

In a case where 4K4x imaging is performed, the processing flow as illustrated in FIG. 5 is performed. In this case, by using the 4K video processing unit 51 on the CCU 12 side, 4K4x imaging can be executed without providing the 4K video processing unit 32 with 4 times the processing speed or a 4-system parallel processing capability on the camera 10 side.

In addition, by performing the compression process, an excessive band burden is not applied even in transmission of the composite optical fiber cable 16.

Note that, for 4K4x imaging, 4 times of processing capability (processing speed or parallel processing capability) is required for imaging and pre-processing by the camera 10, but these have less influence on an increase in the overall processing load of the camera 10 than a case where the 4K video processing unit 32 is compatible with 4-fold speed.

### 3. Processing Example

Processing examples of the CPU 20 and the CPU 40 for realizing the operations illustrated in FIGS. 3, 4, and 5 will be described. In the CPU 20 and the CPU 40, programs for executing the following pieces of processing are installed as software options.

That is, when the option board 50 is attached to the CCU 12 and the corresponding option programs function in the CPU 20 and the CPU 40, the operations as illustrated in FIGS. 3, 4, and 5 can be executed.

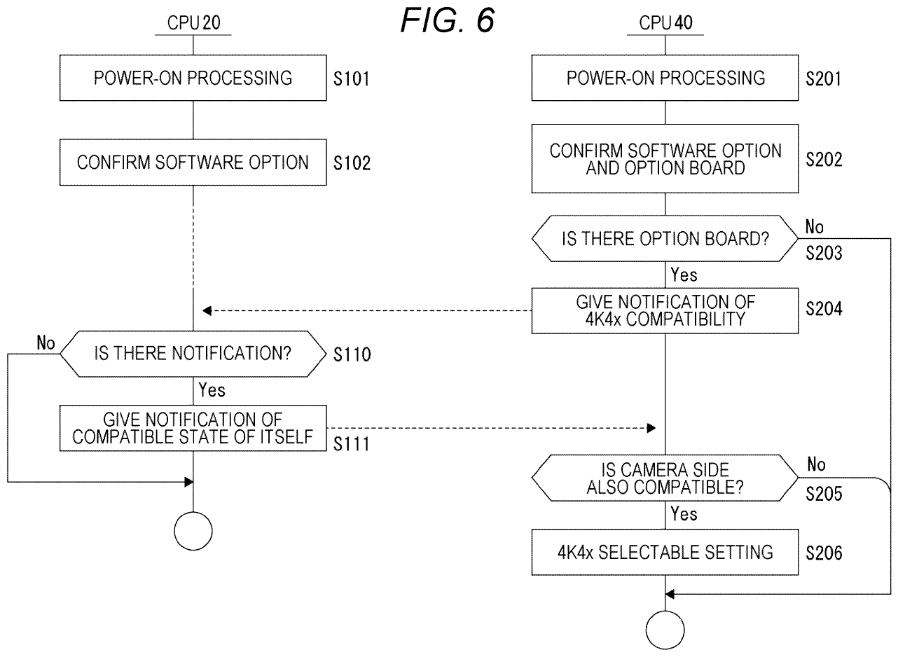

FIG. 6 is a processing example when the power is turned on.

After performing the power-on processing in step S101, the CPU 20 of the camera 10 confirms that the software option is executable in step S102.

After performing the power-on processing in step S201, the CPU 40 of the CCU 12 confirms in step S202 that the software option is executable and also confirms that the option board 50 is attached.

In a case where the option board 50 is removed, since the above-described processing control cannot be performed, the CPU 40 ends the processing of FIG. 6 from step S203. In this case, 4K4x imaging cannot be executed.

In a case where the attachment of the option board 50 has been confirmed, the CPU 40 proceeds from step S203 to step S204 and notifies the CPU 20 that the CCU 12 is compatible with 4K4x. This notification also means that the CPU 40 notifies the CPU 20 that the CPU 40 itself is compatible with 4K4x and make an inquiry as to whether or not the CPU 20 (camera 10) is compatible with 4K4x imaging.

In a case where the CPU 20 receives a notification corresponding to 4K4x from the CPU 20 at a certain point of time after the power-on processing, the processing proceeds from step S110 to step S111, and the CPU 20 gives a notification of the compatibility of itself. Since FIG. 6 illustrates processing by a software option, the CPU 20 performs processing of notifying the CPU 40 that the CPU 20 itself is also compatible.

The CPU 40 receives the notification from the CPU 20, thereby recognizing that the camera 10 side is also compatible with 4K4x imaging, and advances the processing from step S205 to step S206. In this case, the CPU 20 performs 4K4x selectable setting.

For example, the display unit 44 displays that an imaging mode of 4K4x is selectable in addition to 4K1x and 4K2x. In addition, a selection operator of the imaging mode of 4K4x is prepared in addition to 4K1x and 4K2x by an operator as a GUI on the display unit 44.

Note that, in a case where there is a notification of non-4K4x compatibility from the CPU 20 or in a case where there is no notification, the CPU 40 ends the processing of FIG. 6 from step S205. In this case, 4K4x imaging is not selectable.

By the processing of FIG. 6 described above, for example, when the power is turned on, it is confirmed whether or not the camera 10 side and the CCU 12 side are compatible with 4K4x imaging by the method of FIG. 5, and when both sides are compatible with 4K4x imaging, a display and an operator for 4K4x imaging are presented to the operator.

In the combination of the camera 10 and the CCU 12, there are a case where an option program is provided and a case where it is not provided, and there are a case where the option board 50 is mounted in the CCU 12 and a case where it is not mounted. That is, as a combination of the camera 10 and the CCU 12, those compatible with the option of 4K4x are not always connected.

Therefore, in order to confirm whether or not each of the camera 10 and the CCU 12 is compatible with the 4-fold speed, it is necessary to perform a procedure of confirming each other's states (whether or not each of the camera 10 and the CCU 12 is compatible with the option) when the power is turned on. In the present embodiment, the processing as illustrated in FIG. 6 is performed in response to such a request. Thus, an appropriate interface can be provided to the operator.

Note that the example of FIG. 6 is an example in which the compatibility of the CPU 20 is confirmed from the CPU 40 side, but the CPU 20 having a software option may make an inquiry to the CPU 40 of the connected CCU 12, share the result, and perform an operation for 4K4x imaging.

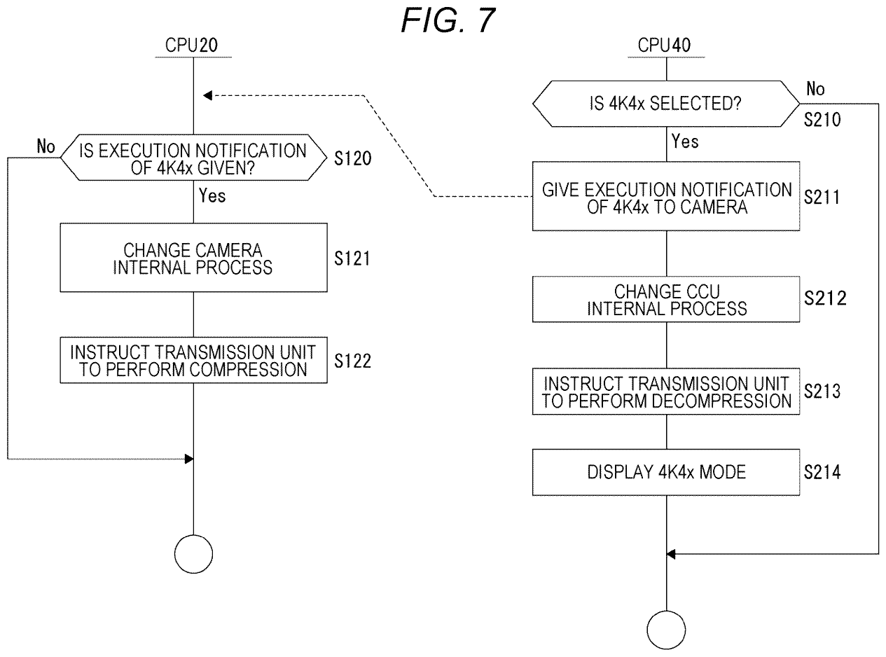

FIG. 7 illustrates a processing example in a case where the 4K4x imaging as illustrated in FIG. 5 is operated by the operator.

When recognizing the 4K4x imaging operation by the operator, the CPU 40 proceeds from step S210 to step S211, and transmits a 4K4x execution notification to the CPU 20 of the camera 10.

Then, in step S212, the CPU 40 changes the internal process of the CCU 12. That is, the state of transmitting the received 4K video signal from the transmission unit 41 to the formatter/conversion unit 42 as illustrated in FIG. 3 or 4 is changed to the state of transmitting the received 4K video signal from the transmission unit 41 to the 4K video processing unit 51 as illustrated in FIG. 5. Furthermore, a 4K1x video signal is input from the 4K video processing unit 51 to the formatter/conversion unit 42. Further, the HD signal is transmitted from the formatter/conversion unit 42 to the camera 10 from the transmission unit 41 for a viewfinder.

Furthermore, in step S213, the CPU 40 instructs the transmission unit 41 to perform decompression processing on the received video signal, that is, the compressed video signal C4K.

In step S214, the CPU 40 causes the display unit 44 to execute a display indicating to the operator that imaging and signal processing are performed in the 4K4x mode.

On the other hand, in a case of receiving the 4K4x execution notification from the CPU 40, the CPU 20 of the camera 10 proceeds from step S120 to step S121, and performs change control of the internal process of the camera 10. That is, the CPU 20 instructs the imaging element unit 21 to perform 4-fold speed imaging, and instructs the pre-processing unit 31 to perform 4-fold speed processing. Further, the CPU 20 instructs the 4K video processing unit 32 to stop the video signal processing and to through-output the 4K4x video signal, and instructs the conversion processing unit 33 to stop the processing. The monitor video signal MV for the viewfinder is also controlled to be an HD video signal received by the transmission unit 23.

In addition, in step S122, the CPU 20 instructs the transmission unit 23 to perform compression processing on the 4K4x video signal and then transmit the 4K4x video signal to the CCU 12.

By performing the above processing of FIG. 7, 4K4x imaging as illustrated in FIG. 5 is executed by the camera 10 and the CCU 12 of the embodiment.

### 4. Summary and Modification

According to the above-described embodiment, the following effects can be obtained.

The camera 10 (imaging device) according to the embodiment includes the imaging element unit 21 capable of outputting a video signal of 4-fold speed (m-fold speed) with 4K resolution (specific resolution), the signal processing unit 22 in which part of processing is compatible with a video signal of up to 2-fold speed (n-fold speed) with 4K resolution, the transmission unit 23 that transmits the video signal output from the signal processing unit 22 to the CCU 12 (imaging signal processing device), and the CPU 20 (control unit) that changes a processing process of the signal processing unit 22 in a case of performing imaging at 4-fold speed with 4K resolution.

Furthermore, the CCU 12 (imaging signal processing device) according to the embodiment includes the transmission unit 41 that receives a video signal output from the camera 10, the 4K video processing unit 51 (signal processing unit) capable of executing part of processing in the camera 10 corresponding to a 4-fold speed video signal with 4K resolution, and the CPU 40 (control unit) that performs control to cause the 4K video processing unit 51 to execute processing on the 4-fold speed video signal with 4K resolution in a case where the camera 10 outputs the 4-fold speed video signal with 4K resolution.

As a result, for example, even in a case where 4K4x video signal processing cannot be performed in the camera 10, 4K4x video signal processing can be performed on the CCU 12 side, and high-frame-rate imaging can be executed. Therefore, 4K4x imaging can be realized by the 4K2x-compatible camera 10, for example, without applying a processing load to the camera 10 side.

Note that, in the embodiment, an example of 4K has been described as the specific resolution, and an example of 4-fold speed (m=4) and 2-fold speed (n=2) has been described, but the present technology is not limited to this example. For example, the technology of the present disclosure is also applicable to a case of 8K resolution or 2K resolution as the specific resolution, and a case of another-fold speed.

The CPU 40 of the CCU 12 according to the embodiment performs processing of transmitting an execution notification of 4K4x imaging to the camera 10 in a case where 4K4x imaging is performed (see step S211 in FIG. 7).

In addition, the CPU 20 of the camera 10 according to the embodiment has described by giving an example of changing the processing process of the signal processing unit 22 in response to the execution notification of 4K4x imaging from the CCU 12 (see step S121 in FIG. 7).

That is, the CCU 12 side transmits an execution notification of 4K4x imaging to the camera 10, and the camera 10 side changes the processing process of the signal processing unit 22 in response to the execution notification. This allows the operator of the CCU 12 to instruct 4K4x imaging as one of imaging options. Therefore, high-frame-rate imaging can be performed by control from the CCU 12 side.

The CPU 40 of the CCU 12 according to the embodiment performs processing of transmitting an execution notification in response to an operation of instructing 4K4x imaging by a user (operator) (see steps S210 and S211 in FIG. 7). When the CCU 12 transmits a 4K4x imaging execution notification to the camera 10 in response to, for example, an operation of selecting 4K4x imaging to the operator, 4K4x imaging can be started by an arbitrary operation of the operator on the CCU 12 side.

Note that it is also possible to perform control such that a 4K4x execution notification is transmitted from the camera 10 side to the CCU 12 by an operation of a camera operator or the like. In this case, the CPU 20 and the CPU 40 may perform similar processing process change and the like.

In the embodiment, an example has been described in which the CPU 20 changes the processing process so that the signal processing unit 22 does not execute part of processing in a case where 4K4x imaging is performed (see step S121 in FIG. 7).

In the camera 10, the CPU 20 skips processing not compatible with 4K4x, for example. The video signal is transmitted to the CCU 12 in an unprocessed state. This prevents an increase in processing load.

The signal processing unit 22 according to the embodiment includes the pre-processing unit 31 capable of pre-processing a 4K4x video signal and the 4K video processing unit 32 capable of video signal processing up to a 4K2x video signal. Then, an example has been described in which the CPU 20 changes the processing process so that the signal processing unit 22 does not execute the video signal processing of the 4K video processing unit 32 in a case where 4K4x imaging is performed (see step S121 in FIG. 7).

The CPU 20 allows the signal processing unit 22 to skip the processing of the 4K video processing unit 32 having the highest processing load. This enables high-frame-rate 4K4x imaging without increasing the processing load on the camera 10 side.

The signal processing unit 22 according to the embodiment includes the conversion processing unit 33 that performs conversion processing on the video signal subjected to the video signal processing by the 4K video processing unit 32 to generate the monitor video signal MV. Then, an example has been described in which the CPU 20 changes the processing process so that the signal processing unit 22 does not execute the conversion processing of the conversion processing unit 33 in a case where 4K4x imaging is performed (see step S121 in FIG. 7).

In addition, the CPU 40 of the CCU 12 performs control to transmit the monitor video signal MV based on the 4K1x video signal processing processed by the 4K video processing unit 51 to the camera 10 in a case where 4K4x imaging is performed (see step S212 in FIG. 7).

The CPU 20 also stops the processing of the conversion processing unit 33 in response to the processing of the 4K video processing unit 32 being skipped. This is because the monitor video signal MV displayed on the viewfinder is supplied from the CCU 12. As a result, unnecessary processing can be prevented from being executed on the camera 10 side.

In the embodiment, in a case where the CPU 20 of the camera 10 performs 4K4x imaging, the transmission unit 23 performs control to transmit the compressed video signal C4K obtained by performing the compression processing on the 4K video signal to the CCU 12 (see step S122 in FIG. 7).

Furthermore, the CPU 40 of the CCU 12 performs control to cause the transmission unit 41 to execute decompression processing on the received compressed video signal C4K in a case where 4K4x imaging is performed (see step S213 in FIG. 7).

As a result, the transmission band load can be reduced in the case of 4K4x in which broadband digital optical transmission is required.

In the embodiment, an example has been described in which the CPU 20 of the camera 10 performs processing of notifying the CCU 12 side that the camera 10 side is also compatible with 4K4x imaging in response to the notification of compatibility with 4K4x imaging from the CCU 12 side (see FIG. 6).

In the case of 4K4x, the camera 10 side becomes compatible with this by skipping the processing of the 4K video processing unit 32. The camera 10 according to the present embodiment includes a software option that allows the CPU 20 to skip processing of the 4K video processing unit 32. That is, it is compatible with the video signal processing corresponding to 4K4x on the CCU 12 side. Therefore, the CPU 20 performs processing of notifying the CCU 12 of compatibility with 4K4x. With this notification, the CCU 12 side can be prepared as one imaging option capable of executing 4K4x imaging.

The 4K video processing unit 51 in the CCU 12 according to the embodiment is mounted on the detachable option board 50, and the option board 50 is attached to the housing of the CCU 12, so that the 4K4x video signal can be processed.

When the option board 50 is attached to the CCU 12, the 4K video processing unit 51 functions. As a result, the CCU 12 can have the function of the present embodiment in an extended manner, and 4K4x high-frame-rate imaging can be enabled by the 4K2x-compatible camera 10.

Note that, as illustrated in FIG. 2, the 4K video processing unit 51 in the option board 50 of the embodiment includes the four signal processing circuits 61, 62, 63, and 64 to enable 4K4x video signal processing. In this case, by using three of the four signal processing circuits (for example, the signal processing circuits 61, 62, and 63), 4K3x video signal processing can be performed and output.

In the embodiment, an example has been described in which the CPU 40 of the CCU 12 performs the processing of transmitting the notification indicating that 4K4x imaging is compatible to the camera 10 side and the processing of enabling the user to select 4K4x imaging in response to receiving the notification indicating that 4K4x imaging is compatible from the camera 10 side (see steps S204, S205, and S206 in FIG. 6).

In a case where the camera 10 side is compatible with 4K4x imaging, that is, in a case where the CPU 20 includes a software option that allows the processing of the 4K video processing unit 32 to be skipped, the CPU 40 sets 4K4x imaging to be selectable. This allows the operator of the CCU 12 to instruct 4K4x imaging as one of the imaging options.

Note that it is also conceivable that the CPU 20 on the camera 10 side make an inquiry to the CPU 40 of the CCU 12 as to whether or not the camera 10 is compatible with 4K4x imaging, that is, whether or not the option board 50 is provided and a video processing unit for 4K4x is compatible, and in that case, the CPU 40 sets 4K4x imaging to be selectable.

In the embodiment, an example has been described in which the CPU 40 of the CCU 12 performs control such that the 4K video processing unit 51 performs 4-fold speed video signal processing in a case where 4K4x imaging is performed (see step S212 in FIG. 7).

The CPU 40 causes the 4K video processing unit 51 to perform signal processing on the video signal received by the transmission unit 41. As a result, the processing skipped on the camera 10 side is executed on the CCU 12 side.

In the embodiment, an example has been described in which, in a case where 4K4x imaging is performed, the CPU 40 of the CCU 12 performs control to present the fact to the user (see step S214 in FIG. 7).

As a result, the user can recognize a state in which 4K4x imaging is performed.

Note that the effects described in the present specification are merely examples and are not restrictive, and other effects may also be produced.

Note that the present technology can also adopt the following configurations.

(1)

An imaging device including:
an imaging element unit capable of outputting a video signal at m-fold speed with a specific resolution;
a signal processing unit in which part of processing is compatible with a video signal at up to n-fold speed, which is lower than the m-fold speed, with the specific resolution;
a transmission unit that transmits a video signal output from the signal processing unit to an imaging signal processing device; and
a control unit that changes a processing process of the signal processing unit in a case of performing imaging at the m-fold speed with the specific resolution.

(2)

The imaging device according to (1), in which
the control unit
changes a processing process of the signal processing unit in response to an execution notification of imaging at the m-fold speed with the specific resolution from the imaging signal processing device.

(3)

The imaging device according to (1) or (2), in which
the control unit changes a processing process so that the signal processing unit does not execute the part of processing in a case where imaging at the m-fold speed is performed with the specific resolution.

(4)

The imaging device according to any one of (1) to (3), in which
the signal processing unit includes:
a pre-processing unit capable of pre-processing a video signal at the m-fold speed with the specific resolution; and
a video processing unit capable of video signal processing on a video signal of up to the n-fold speed with the specific resolution, and
the control unit changes a processing process so that the signal processing unit does not execute the video signal processing of the video processing unit in a case where imaging at the m-fold speed is performed with the specific resolution.

(5)

The imaging device according to (4), in which
the signal processing unit includes
a conversion processing unit that generates a monitor video signal by performing conversion processing on a video signal subjected to video signal processing by the video processing unit, and
the control unit
changes a processing process so that the conversion processing of the conversion processing unit is not executed in the signal processing unit in a case where imaging at the m-fold speed is performed with the specific resolution.

(6)

The imaging device according to any one of (1) to (5), in which
the control unit
performs control so that the transmission unit performs compression processing on a video signal and then transmits the video signal to the imaging signal processing device in a case where imaging at the m-fold speed is performed with the specific resolution.

(7)

The imaging device according to any one of (1) to (6), in which
the control unit
performs processing of notifying the imaging signal processing device that the imaging device side is also compatible with imaging at the m-fold speed with the specific resolution in response to a notification from the imaging signal processing device indicating compatibility with the imaging at the m-fold speed with the specific resolution.

(8)

The imaging device according to any one of (1) to (7), in which
the specific resolution is 4K resolution, the m-fold speed is a 4-fold speed, and the n-fold speed is a 2-fold speed.

(9)

An imaging signal processing device including:
a transmission unit that receives a video signal output from an imaging device including an imaging element unit capable of outputting a video signal at m-fold speed with a specific resolution, a part of processing being compatible with a video signal of up to n-fold speed lower than the m-fold speed with the specific resolution;
a signal processing unit capable of executing the part of processing in the imaging device corresponding to the video signal at the m-fold speed with the specific resolution; and
a control unit that performs control for causing the signal processing unit to execute the part of processing on the video signal at the m-fold speed with the specific resolution in a case where the imaging device outputs the video signal at the m-fold speed with the specific resolution.

(10)

The imaging signal processing device according to (9), in which
the signal processing unit is mounted on a detachable option board, and the option board is attached to a housing, so that processing can be performed on the video signal at the m-fold speed with the specific resolution output from the imaging device.

(11)

The imaging signal processing device according to (9) or (10), in which
the control unit performs:
processing of transmitting a notification indicating that the imaging device is compatible with the m-fold speed imaging with the specific resolution to the imaging device; and
processing of enabling a user to select the m-fold speed imaging with the specific resolution in response to reception of the notification indicating that the imaging device is compatible with the m-fold speed imaging.

(12)

The imaging signal processing device according to any one of (9) to (11), in which
the control unit
performs processing of transmitting an execution notification of the m-fold speed imaging with the specific resolution to the imaging device in a case where imaging at the m-fold speed is performed with the specific resolution.

(13)

The imaging signal processing device according to (12), in which
the control unit
performs processing of transmitting the execution notification in response to an operation of a user of instructing the m-fold speed imaging with the specific resolution.

(14)

The imaging signal processing device according to any one of (9) to (13), in which
the control unit
controls the signal processing unit to perform video signal processing at the m-fold speed with the specific resolution in a case where the imaging device performs the m-fold speed imaging with the specific resolution.

(15)

The imaging signal processing device according to any one of (9) to (14), in which
the control unit
performs control to cause the transmission unit to execute decompression processing on a received video signal in a case where the imaging device performs imaging at the m-fold speed with the specific resolution.

(16)

The imaging signal processing device according to any one of (9) to (15), in which
the control unit
performs control to present to a user that the m-fold speed imaging is executed with the specific resolution in a case where the imaging device performs the m-fold speed imaging with the specific resolution.

(17)

The imaging signal processing device according to any one of (9) to (16), in which
the control unit
performs control such that a monitor signal based on video signal processing processed by the signal processing unit is transmitted to the imaging device in a case where the imaging device performs imaging at the m-fold speed with the specific resolution.

(18)

An imaging system including: an imaging device; and an imaging signal processing device, in which
the imaging device includes:
an imaging element unit capable of outputting a video signal at m-fold speed with a specific resolution;
a first signal processing unit in which part of processing is compatible with a video signal of up to n-fold speed, which is lower than the m-fold speed, with the specific resolution;
a first transmission unit that transmits a video signal output from the first signal processing unit to the imaging signal processing device; and
a first control unit that changes a processing process of the first signal processing unit in a case of performing imaging of the m-fold speed with the specific resolution, and
the imaging signal processing device includes:
a second transmission unit that receives a video signal output from the imaging device;
a second signal processing unit capable of executing the part of processing in the imaging device corresponding to the video signal at the m-fold speed with the specific resolution; and
a second control unit that performs control to cause the second signal processing unit to execute the part of processing on the video signal at the m-fold speed with the specific resolution in a case where the imaging device outputs the video signal at the m-fold speed with the specific resolution.

Furthermore, the present technology can also adopt the following configurations (100) and (101).

In addition, the following (100) can combine the technical elements of the above (2) to (8), and the following (101) can combine the technical elements of the above (10) to (17).

(100)

An imaging method, in which
an imaging device includes:
an imaging element unit capable of outputting a video signal at m-fold speed with a specific resolution;
a signal processing unit in which part of processing is compatible with a video signal at up to n-fold speed, which is lower than the m-fold speed, with the specific resolution; and
a transmission unit that transmits a video signal output from the signal processing unit to an imaging signal processing device, and
the imaging device performs processing of changing a processing process of the signal processing unit in a case of performing imaging at the m-fold speed with the specific resolution.

(101)

An imaging signal processing method,
in which an imaging signal processing device includes:
a transmission unit that receives a video signal output from an imaging device including an imaging element unit capable of outputting a video signal at m-fold speed with a specific resolution, a part of processing being compatible with a video signal of up to n-fold speed lower than the m-fold speed with the specific resolution; and
a signal processing unit capable of executing the part of processing in the imaging device corresponding to the video signal at the m-fold speed with the specific resolution, and
the imaging signal processing device causes the signal processing unit to execute the part of processing on the video signal at the m-fold speed with the specific resolution in a case where the imaging device outputs the video signal at the m-fold speed with the specific resolution.

### REFERENCE SIGNS LIST

1 Camera system
10 Camera
12 CCU
16 Composite optical fiber cable
20 CPU
21 Imaging element unit
22 Signal processing unit
23 Transmission unit
31 Pre-processing unit
32 4K video processing unit
33 Conversion processing unit
40 CPU
41 Transmission unit
42 Formatter/conversion unit
43 Input unit
44 Display unit
45 Operation unit
50 Option board
51 4K video processing unit

1. An imaging device comprising:
an imaging element unit capable of outputting a video signal at m-fold speed with a specific resolution;
a signal processing unit in which part of processing is compatible with a video signal at up to n-fold speed, which is lower than the m-fold speed, with the specific resolution;
a transmission unit that transmits a video signal output from the signal processing unit to an imaging signal processing device; and
a control unit that changes a processing process of the signal processing unit in a case of performing imaging at the m-fold speed with the specific resolution.

2. The imaging device according to claim 1, wherein
the control unit
changes a processing process of the signal processing unit in response to an execution notification of imaging at the m-fold speed with the specific resolution from the imaging signal processing device.

3. The imaging device according to claim 1, wherein
the control unit changes a processing process so that the signal processing unit does not execute the part of processing in a case where imaging at the m-fold speed is performed with the specific resolution.

4. The imaging device according to claim 1, wherein
the signal processing unit includes:
a pre-processing unit capable of pre-processing a video signal at the m-fold speed with the specific resolution; and
a video processing unit capable of video signal processing on a video signal of up to the n-fold speed with the specific resolution, and
the control unit changes a processing process so that the signal processing unit does not execute the video signal processing of the video processing unit in a case where imaging at the m-fold speed is performed with the specific resolution.

5. The imaging device according to claim 4, wherein
the signal processing unit includes
a conversion processing unit that generates a monitor video signal by performing conversion processing on a video signal subjected to video signal processing by the video processing unit, and
the control unit
changes a processing process so that the conversion processing of the conversion processing unit is not executed in the signal processing unit in a case where imaging at the m-fold speed is performed with the specific resolution.

6. The imaging device according to claim 1, wherein
the control unit
performs control so that the transmission unit performs compression processing on a video signal and then transmits the video signal to the imaging signal processing device in a case where imaging at the m-fold speed is performed with the specific resolution.

7. The imaging device according to claim 1, wherein
the control unit
performs processing of notifying the imaging signal processing device that the imaging device side is also compatible with imaging at the m-fold speed with the specific resolution in response to a notification from the imaging signal processing device indicating compatibility with the imaging at the m-fold speed with the specific resolution.

8. The imaging device according to claim 1, wherein
the specific resolution is 4K resolution, the m-fold speed is a 4-fold speed, and the n-fold speed is a 2-fold speed.

9. An imaging signal processing device comprising:
a transmission unit that receives a video signal output from an imaging device including an imaging element unit capable of outputting a video signal at m-fold speed with a specific resolution, a part of processing being compatible with a video signal of up to n-fold speed lower than the m-fold speed with the specific resolution;
a signal processing unit capable of executing the part of processing in the imaging device corresponding to the video signal at the m-fold speed with the specific resolution; and
a control unit that performs control for causing the signal processing unit to execute the part of processing on the video signal at the m-fold speed with the specific resolution in a case where the imaging device outputs the video signal at the m-fold speed with the specific resolution.

10. The imaging signal processing device according to claim 9, wherein
the signal processing unit is mounted on a detachable option board, and the option board is attached to a housing, so that processing can be performed on the video signal at the m-fold speed with the specific resolution output from the imaging device.

11. The imaging signal processing device according to claim 9, wherein
the control unit performs:
processing of transmitting a notification indicating that the imaging device is compatible with the m-fold speed imaging with the specific resolution to the imaging device; and
processing of enabling a user to select the m-fold speed imaging with the specific resolution in response to reception of the notification indicating that the imaging device is compatible with the m-fold speed imaging.

12. The imaging signal processing device according to claim 9, wherein
the control unit
performs processing of transmitting an execution notification of the m-fold speed imaging with the specific resolution to the imaging device in a case where imaging at the m-fold speed is performed with the specific resolution.

13. The imaging signal processing device according to claim 12, wherein
the control unit
performs processing of transmitting the execution notification in response to an operation of a user of instructing the m-fold speed imaging with the specific resolution.

14. The imaging signal processing device according to claim 9, wherein
the control unit
controls the signal processing unit to perform video signal processing at the m-fold speed with the specific resolution in a case where the imaging device performs the m-fold speed imaging with the specific resolution.

15. The imaging signal processing device according to claim 9, wherein
the control unit
performs control to cause the transmission unit to execute decompression processing on a received video signal in a case where the imaging device performs imaging at the m-fold speed with the specific resolution.

16. The imaging signal processing device according to claim 9, wherein
the control unit
performs control to present to a user that the m-fold speed imaging is executed with the specific resolution in a case where the imaging device performs the m-fold speed imaging with the specific resolution.

17. The imaging signal processing device according to claim 9, wherein
the control unit
performs control such that a monitor signal based on video signal processing processed by the signal processing unit is transmitted to the imaging device in a case where the imaging device performs imaging at the m-fold speed with the specific resolution.

18. An imaging system comprising: an imaging device; and an imaging signal processing device, wherein
the imaging device includes:
an imaging element unit capable of outputting a video signal at m-fold speed with a specific resolution;
a first signal processing unit in which part of processing is compatible with a video signal of up to n-fold speed, which is lower than the m-fold speed, with the specific resolution;
a first transmission unit that transmits a video signal output from the first signal processing unit to the imaging signal processing device; and
a first control unit that changes a processing process of the first signal processing unit in a case of performing imaging at the m-fold speed with the specific resolution, and
the imaging signal processing device includes:
a second transmission unit that receives a video signal output from the imaging device;
a second signal processing unit capable of executing the part of processing in the imaging device corresponding to the video signal at the m-fold speed with the specific resolution; and
a second control unit that performs control to cause the second signal processing unit to execute the part of processing on the video signal at the m-fold speed with the specific resolution in a case where the imaging device outputs the video signal at the m-fold speed with the specific resolution.
